(19) United States
(12) Patent Application Publication
(10) Pub. No.: US 2014/0057578 A1
(43) Pub. Date: Feb. 27, 2014

(54) Mobile Device and Antenna Structure Therein

(71) Applicants: Shih-Yi CHAN, Taipei City (TW); Tung-Liang WANG, New Taipei City (TW)

(72) Inventors: Shih-Yi CHAN, Taipei City (TW); Tung-Liang WANG, New Taipei City (TW)

(73) Assignee: Shih-Yi CHAN, Taipei City (TW)

(21) Appl. No.: 13/594,260

(22) Filed: Aug. 24, 2012

(51) Int. Cl. H04B 1/40; H04B 1/38

(52) U.S. Cl. 455/77; 455/73

(57) ABSTRACT

A mobile device including an antenna structure is provided. The antenna structure includes a main radiation element, a parasitical element, and a tunable element. The main radiation element has a feeding pin coupled to a signal source, wherein the feeding pin is substantially located at an end of the main radiation element. The parasitical element is close to the main radiation element, and has a parasitical pin which is substantially located at an end of the parasitical element. The tunable element includes a switch and a plurality of paths, wherein the switch selectively couples one of the paths to the parasitical pin in such a manner that the antenna structure operates in multiple bands.

### BACKGROUND OF THE INVENTION

1. Field of the Invention

The disclosure generally relates to a mobile device, and more particularly, relates to a mobile device and an antenna structure therein.

2. Description of the Related Art

With the progress of mobile communication technology, portable electronic devices, for example, portable computers, mobile phones, multimedia players, and other hybrid functional portable electronic devices, have become more common. To satisfy the demand of users, portable electronic devices usually can perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, mobile phones using Wi-Fi, Bluetooth, and WiMAX (Worldwide Interoperability for Microwave Access) systems and using frequency bands of 3.5 GHz, 5.2 GHz, and 5.8 GHz.

Traditionally, a metal element with a fixed size is used as a main body of an antenna. The metal element is one-second wavelength or one-fourth wavelength in length, wherein the wavelength corresponds to the desired frequency band. Traditional designs limit the sizes and shapes of the metal element so that it is difficult to design an aesthetic appearance of the antennas.

### BRIEF SUMMARY OF THE INVENTION

In one exemplary embodiment, the disclosure is directed to a mobile device, comprising: an antenna structure, comprising: a main radiation element, having a feeding pin coupled to a signal source, wherein the feeding pin is substantially located at an end of the main radiation element; a first parasitical element, close to the main radiation element, and having a first parasitical pin, wherein the first parasitical pin is substantially located at an end of the first parasitical element; and a first tunable element, comprising a first switch and a plurality of paths, wherein the first switch selectively couples one of the paths to the first parasitical pin in such a manner that the antenna structure operates in multiple bands.

### BRIEF DESCRIPTION OF DRAWINGS

The invention can be more fully understood by reading the subsequent detailed description and examples with references made to the accompanying drawings, wherein:

FIG. 1A is a diagram for illustrating a mobile device and an antenna structure therein according to an embodiment of the invention;

FIG. 1B is a diagram for illustrating a tunable element coupled to a parasitical element according to an embodiment of the invention;

FIG. 2A is a diagram for illustrating a mobile device and an antenna structure therein according to an embodiment of the invention;

FIG. 2B is a diagram for illustrating a mobile device and an antenna structure therein according to another embodiment of the invention;

FIG. 3 is a diagram for illustrating a mobile device and an antenna structure therein according to an embodiment of the invention;

FIG. 4 is a diagram for illustrating a mobile device and an antenna structure therein according to a preferred embodiment of the invention;

FIGS. 5A-5M are diagrams for illustrating antenna structures according to some embodiments of the invention;

FIG. 6A is a diagram for illustrating a tunable element coupled to a parasitical pin of a parasitical element according to an embodiment of the invention;

FIG. 6B is a diagram for illustrating a tunable element coupled to a tuning pin of a branch according to an embodiment of the invention;

FIG. 7A is a diagram for illustrating return loss of an antenna structure according to an embodiment of the invention;

FIG. 7B is a diagram for illustrating return loss of an antenna structure according to an embodiment of the invention; and

FIG. 8 is a diagram for illustrating a mobile device and an antenna structure therein according to an embodiment of the invention.

### DETAILED DESCRIPTION OF THE INVENTION

In order to illustrate the purposes, features and advantages of the invention, the embodiments and figures thereof in the invention are shown in detail as follows.

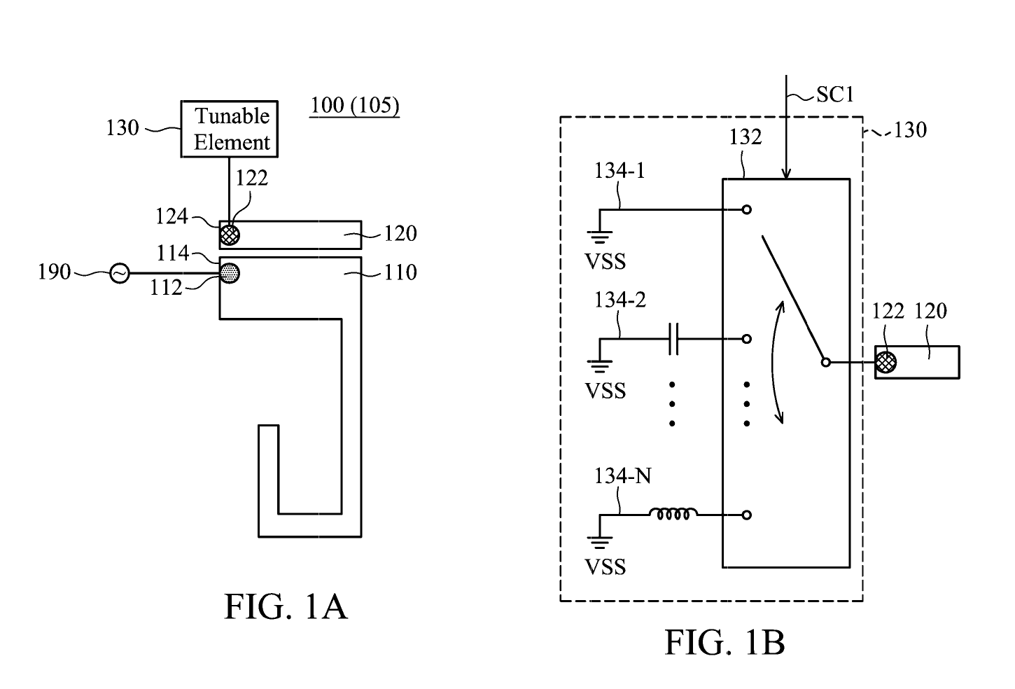

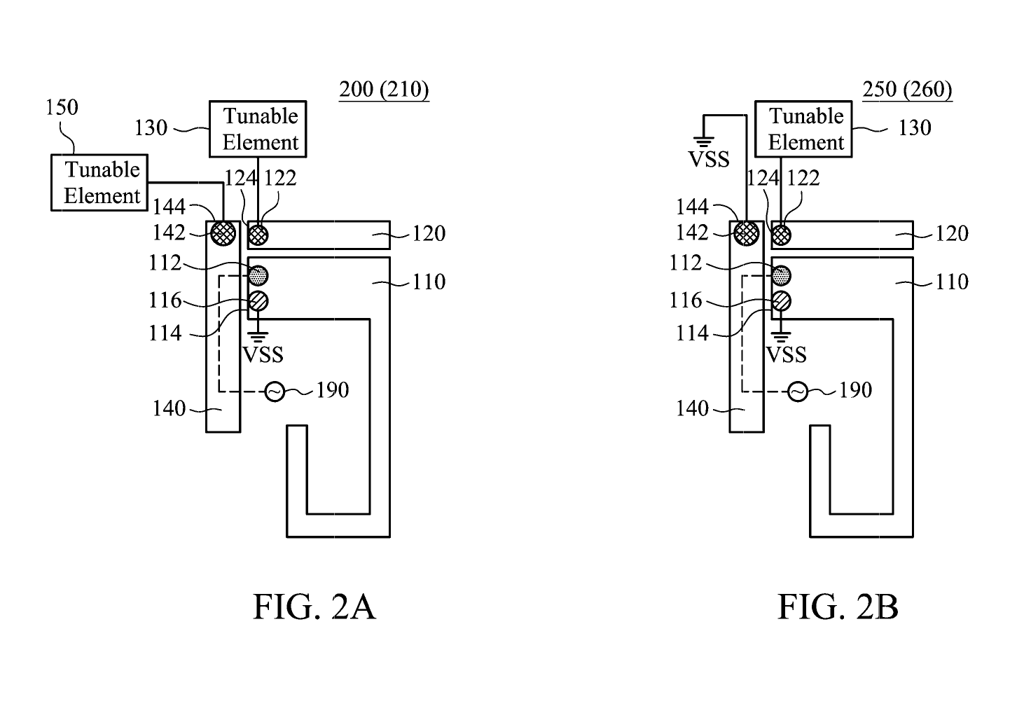

FIG. 1A is a diagram for illustrating a mobile device 100 and an antenna structure 105 therein according to an embodiment of the invention. The mobile device 100 may be a mobile phone, a tablet computer, or a notebook computer. As shown in FIG. 1A, the mobile device 100 comprises at least the antenna structure 105, and the antenna structure 105 comprises a main radiation element 110, a parasitical element 120, and a tunable element 130. In some embodiments, the mobile device 100 may further comprise other essential components, such as a processor, a transceiver, a housing, and a touch panel (not shown in FIG. 1A).

The main radiation element 110 and the parasitical element 120 may be made of metal, such as copper, silver, or aluminum. The parasitical element 120 is independent of the main radiation element 110. The main radiation element 110 has a feeding pin 112 which is coupled to a signal source 190 (“pin” herein may be a connection point on an element, and the element is coupled through the connection point to another element). The feeding pin 112 is substantially located at an end 114 of the main radiation element 110. The parasitical element 120 is close to the main radiation element 110. A gap G1 between the parasitical element 120 and the main radiation element 110 is very small such that the mutual coupling therebetween is enhanced. The parasitical element 120 has a parasitical pin 122. The parasitical pin 122 is close to the feeding pin 112, and is substantially located at an end 124 of the parasitical element 120. In the embodiment, the main radiation element 110 substantially has a C-shape, and the parasitical element 120 substantially has an I-shape. Note that the invention is not limited to the above. In other embodiments, the main radiation element 110 and the parasitical element 120 may have other shapes, such as L-shapes or S-shapes.

FIG. 1B is a diagram for illustrating the tunable element 130 coupled to the parasitical element 120 according to an embodiment of the invention. As shown in FIG. 1B, the tunable element 130 comprises a switch 132 and a plurality of paths 134-1, 134-2, . . . , and 134-N (N is an integer which is greater than or equal to 2). The path 134-1 may be a shorted path which is directly coupled to a ground node VSS, and each of the other paths 134-2, . . . , and 134-N may comprise one or more circuit elements, such as one or more capacitors, inductors, and/or resistors. Note that the invention is not limited to the above. In another embodiment, the path 134-1 may also comprise one or more circuit elements. In some embodiments, the shorted path may be replaced with an open path. The shorted path and the open path may be implemented with one or more microstrip lines. The switch 132 selectively couples one of the paths 134-1, 134-2, . . . , and 134-N to the parasitical pin 122 of the parasitical element 120 in such a manner that the antenna structure 105 of the mobile device 100 can operate in multiple bands. In some embodiments, the switch 132 may switch between the paths 134-1, 134-2, . . . , and 134-N in response to a user input or a control signal SC1 which is generated by a processor (not shown) of the mobile device 100. To improve impedance matching, a matching circuit (not shown) may be incorporated and coupled between the parasitical pin 122 and the switch 132.

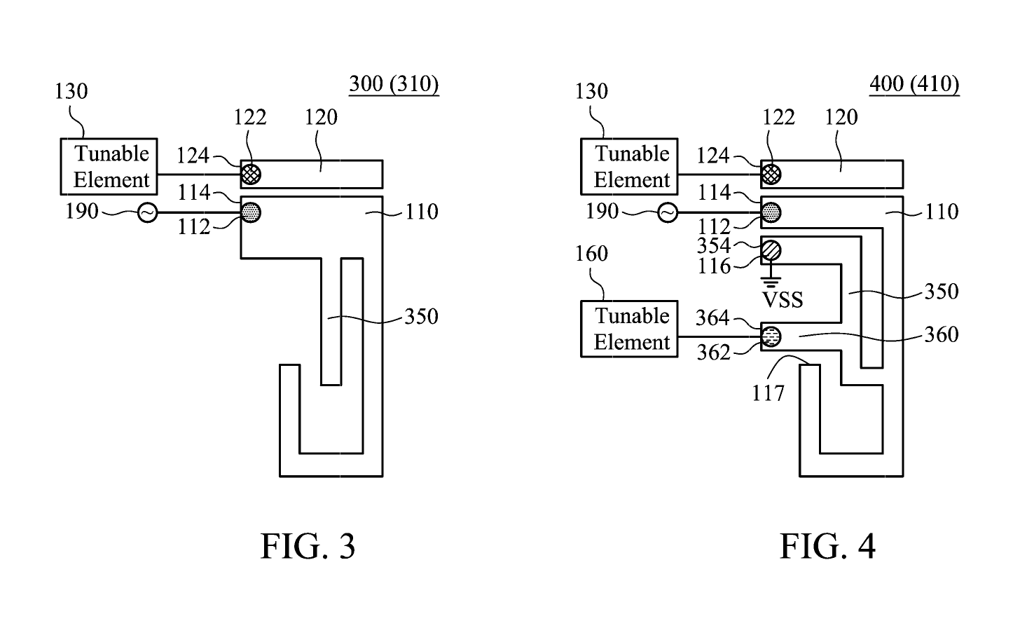

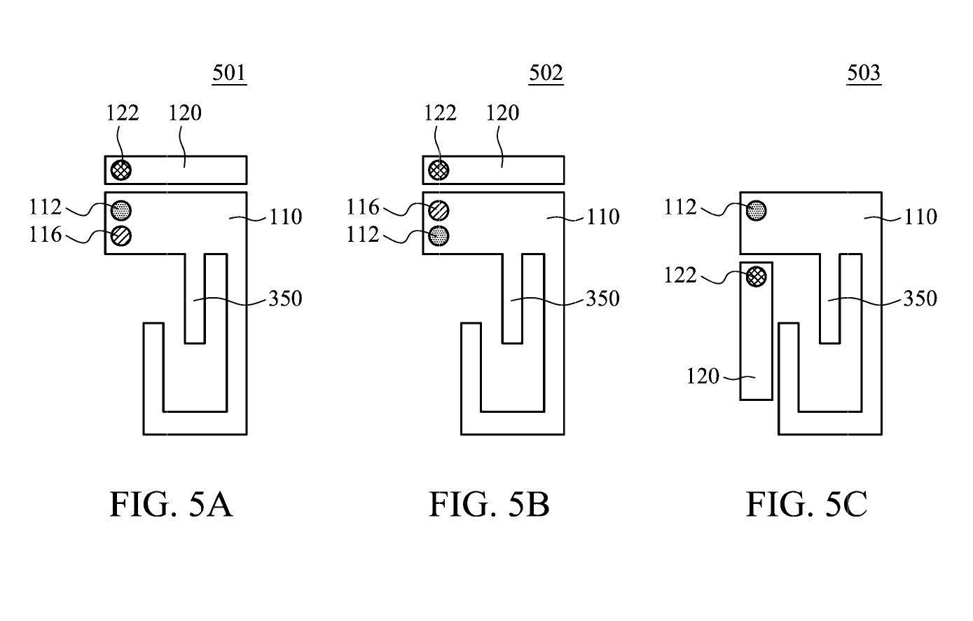

FIG. 2A is a diagram for illustrating a mobile device 200 and an antenna structure 210 therein according to an embodiment of the invention. In comparison to FIG. 1A, the antenna structure 210 further comprises another parasitical element 140 and another tunable element 150, and the main radiation element 110 further has a grounding pin 116 coupled to the ground node VSS. The parasitical element 140 is also independent of the main radiation element 110. Similarly, the parasitical element 140 is close to the main radiation element 110, and has a parasitical pin 142, wherein the parasitical pin 142 is close to the feeding pin 112, and is substantially located at an end 144 of the parasitical element 140. A switch of the tunable element 150 is coupled to the parasitical pin 142. A plurality of paths of the tunable element 150 may be the same as or different from those of the tunable element 130. The internal components and functions of the tunable element 150 are similar to those of the tunable element 130 as shown in FIG. 1B, and they will be not illustrated again here. The grounding pin 116 is close to the feeding pin 112, and is configured to adjust impedance matching of the antenna structure 210. In another embodiment, the grounding pin 116 may be removed from the main radiation element 110.

FIG. 2B is a diagram for illustrating a mobile device 250 and an antenna structure 260 therein according to another embodiment of the invention. FIG. 2B is similar to FIG. 2A. The only difference between the two embodiments is that in the antenna structure 260, the parasitical pin 142 is coupled to the ground node VSS, not the tunable element 150. In another embodiment, adjustments may be made where the parasitical pin 122 of the parasitical element 120 is coupled to the ground node VSS and the parasitical pin 142 of the parasitical element 140 is coupled to the tunable element 130. In the invention, the antenna structure may comprise a plurality of parasitical elements, and at least one parasitical pin of these parasitical elements is coupled to a tunable element such that the antenna structure can cover multiple bands. The other parasitical pins are not restricted, and may be coupled to the ground node VSS or other tunable elements according to different desired bands.

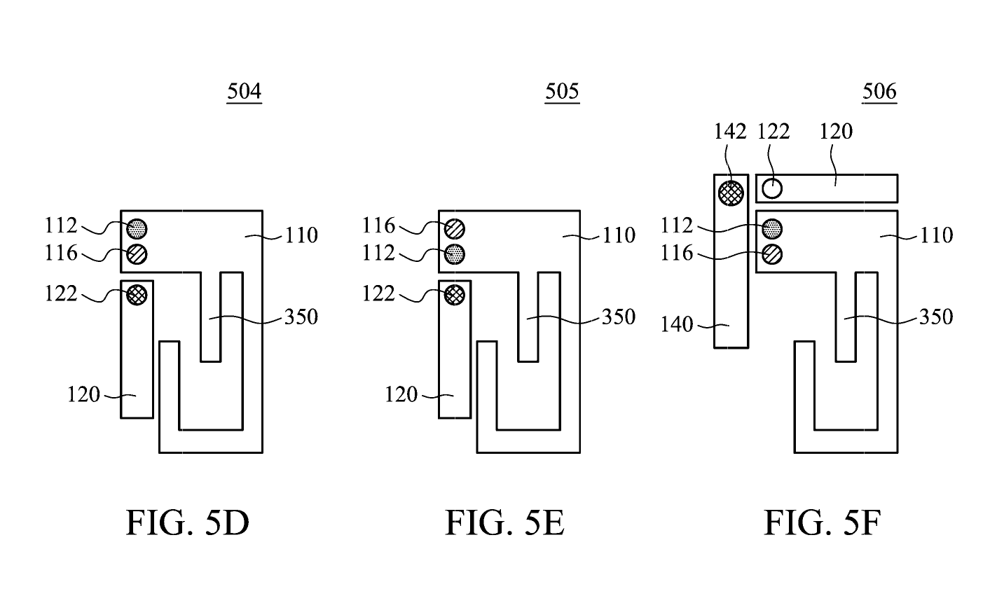

FIG. 3 is a diagram for illustrating a mobile device 300 and an antenna structure 310 therein according to an embodiment of the invention. In comparison to FIG. 1A, the antenna structure 310 further comprises a branch 350. The branch 350 is coupled to the main radiation element 110, and is partially surrounded by the main radiation element 110. Generally, the branch 350 is shorter than the main radiation element 110, and is configured to generate a high-frequency band. In the embodiment, the branch 110 substantially has an I-shape. Note that the invention is not limited to the above. In other embodiments, the branch 350 may have other shapes, such as an L-shape or an S-shape.

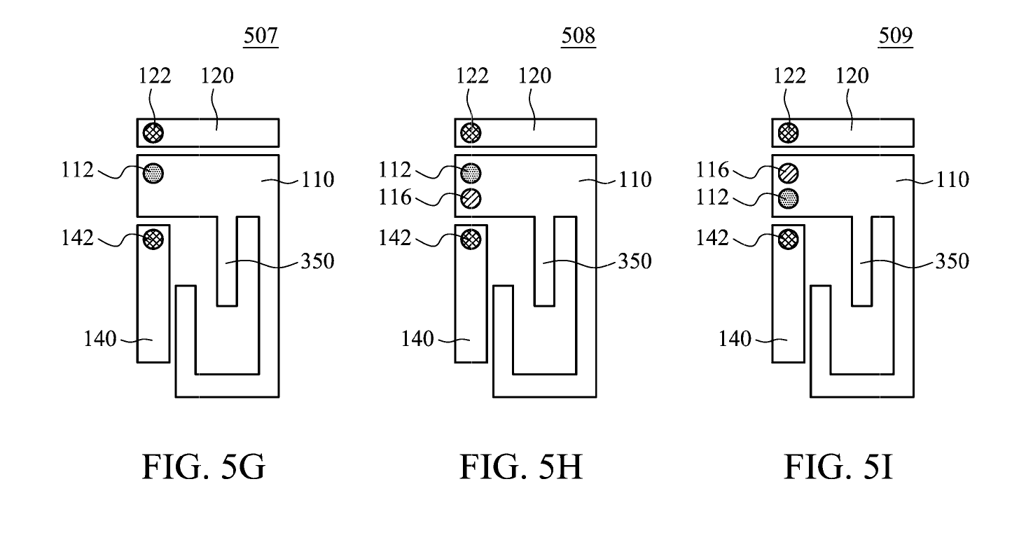

FIG. 4 is a diagram for illustrating a mobile device 400 and an antenna structure 410 therein according to a preferred embodiment of the invention. In comparison to FIG. 1A, the antenna structure 410 further comprises two branches 350 and 360 and another tunable element 160. The branch 350 is coupled to the main radiation element 110, and is partially surrounded by the main radiation element 110. The branch 360 is coupled to the branch 350, and is also partially surrounded by the main radiation element 110. Generally, the branches 350 and 360 are both shorter than the main radiation element 110, and are configured to generate high-frequency bands. In the embodiment, the branch 350 substantially has an L-shape, and the branch 360 substantially has an I-shape. Note that the invention is not limited to the above. In other embodiments, the branches 350 and 360 may have other shapes, such as L-shapes or S-shapes. In addition, the antenna structure 410 further has a grounding pin 116 and a tuning pin 362. The grounding pin 116 is coupled to the ground node VSS, and is substantially located at an end 354 of the branch 350. The tuning pin 362 is substantially located at an end 364 of the branch 360. A switch of the tunable element 160 is coupled to the tuning pin 362. A plurality of paths of the tunable element 160 may be the same as or different from those of the tunable element 130. To improve impedance matching, a matching circuit (not shown) may be incorporated and coupled between tuning pin 362 and the switch of the tunable element 160. The internal components and functions of the tunable element 160 are similar to those of the tunable element 130 as shown in FIG. 1B, and they will be not illustrated again here. As a matter of fact, the tuning pin 362 may be located at any part of the main radiation element 110, the branch 350, or the branch 360. For example, the tuning pin 362 may be changed to be substantially located at another end 117 of the main radiation element 110. In the embodiment, the tunable element 160 coupled to the tuning pin 362 is mainly configured to adjust low-frequency bands of the antenna structure 410, and the tunable element 130 coupled to the parasitical pin 122 is mainly configured to adjust high-frequency bands of the antenna structure 410.

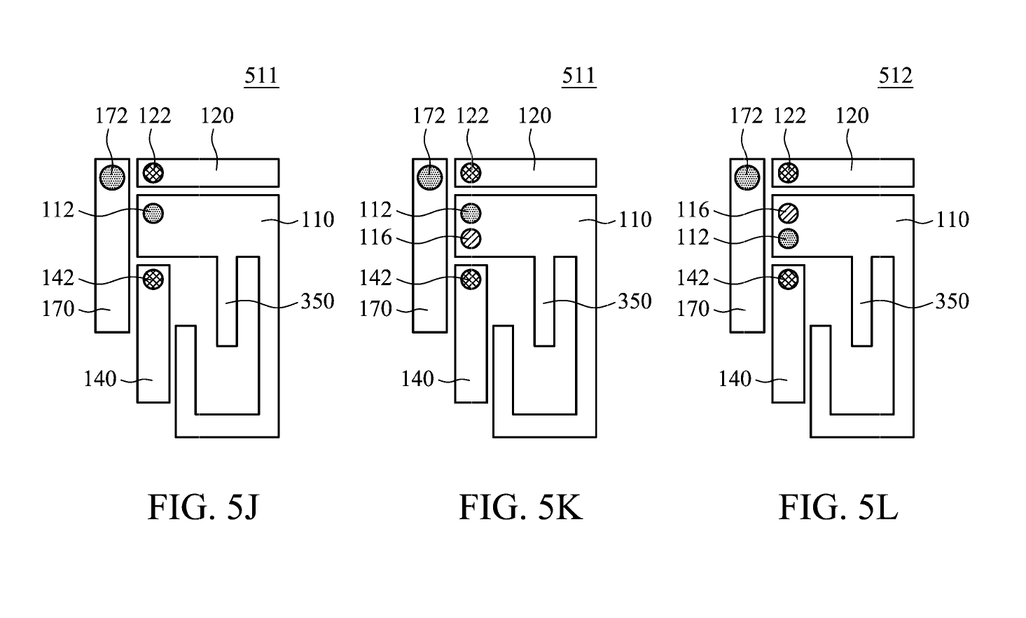

FIGS. 5A-5M are diagrams for illustrating antenna structures according to some embodiments of the invention. In the embodiments, an antenna structure may comprise one, two, three or more parasitical elements, which are all independent of a main radiation element of the antenna structure. As mentioned above, at least one parasitical pin of these parasitical elements is coupled to a tunable element, and the other parasitical pins are not restricted and may be coupled to the ground node VSS or other tunable elements. Each parasitical pin should be close to a feeding pin of the antenna structure. Furthermore, a grounding pin may be included to adjust impedance matching of the antenna structure, and a tuning pin may be included such that the antenna structure can operate in more bands. In some embodiments, the position of the grounding pin may be interchanged with that of the feeding pin. Since these antenna structures in FIGS. 5A-5M are similar to the antenna structure 105 in FIG. 1A, they may all have similar performances.

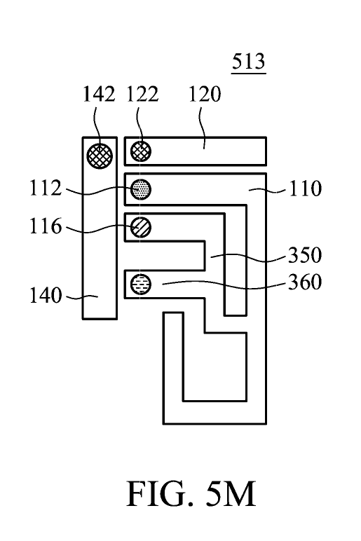

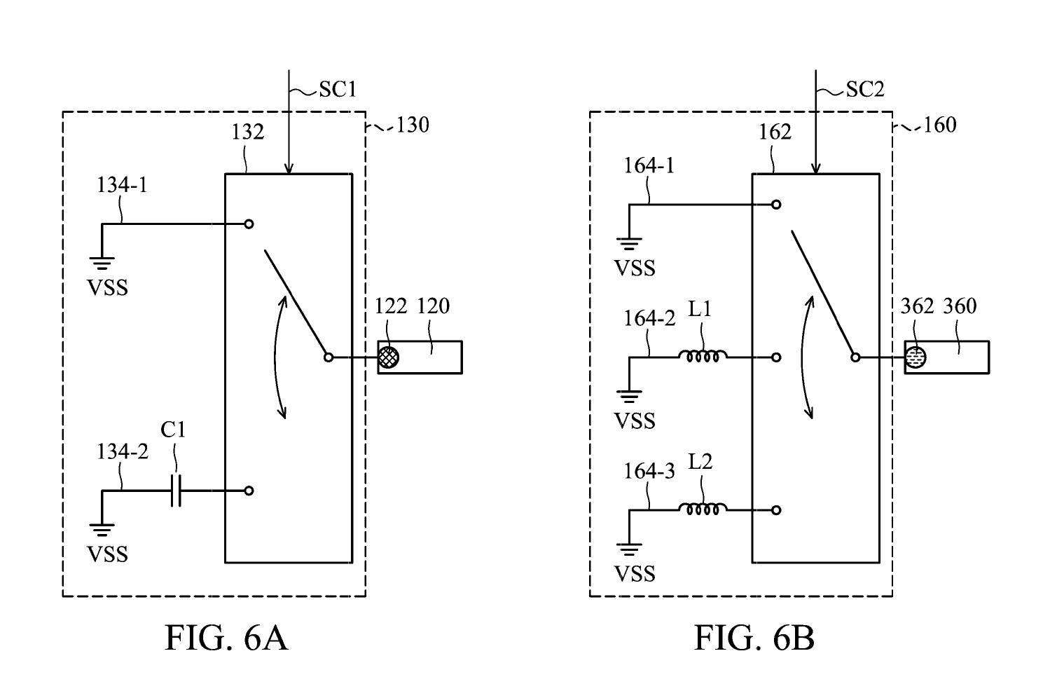

Refer back to FIG. 4. In a preferred embodiment, the tunable elements 130 and 160 of the antenna structure 410 are configured as follows. FIG. 6A is a diagram for illustrating the tunable element 130 coupled to the parasitical pin 122 of the parasitical element 120 according to an embodiment of the invention. As shown in FIG. 6A, the tunable element 130 comprises a switch 132 and two paths 134-1 and 134-2. The path 134-1 is a shorted path coupled to the ground node VSS, and the path 134-2 comprises a capacitor C1 coupled to the ground node VSS. The switch 132 selectively couples one of the paths 134-1 and 134-2 to the parasitical pin 122 of the parasitical element 120. In some embodiments, the switch 132 may switch between the paths 134-1 and 134-2 in response to a user input or a control signal SC1 which is generated by a processor (not shown) of the mobile device 400. FIG. 6B is a diagram for illustrating the tunable element 160 coupled to the tuning pin 362 of the branch 360 according to an embodiment of the invention. As shown in FIG. 6B, the tunable element 160 comprises a switch 162 and three paths 164-1, 164-2 and 164-3. The path 164-1 is a shorted path coupled to the ground node VSS, the path 164-2 comprises an inductor L1 coupled to the ground node VSS, and the path 164-3 comprises another inductor L2 coupled to the ground node VSS. The switch 162 selectively couples one of the paths 164-1, 164-2 and 164-3 to the tuning pin 362 of the branch 360. Similarly, the switch 162 may switch between the paths 164-1, 164-2 and 164-3 in response to a user input or a control signal SC2 which is generated by the processor of the mobile device 400. In an embodiment, the capacitance of the capacitor C1 is about 0.5 pF, the inductance of the inductor L1 is about 3.3 nH, and the inductance of the inductor L2 is about 7.2 nH. The foregoing parameters are adjustable according to different desired bands.

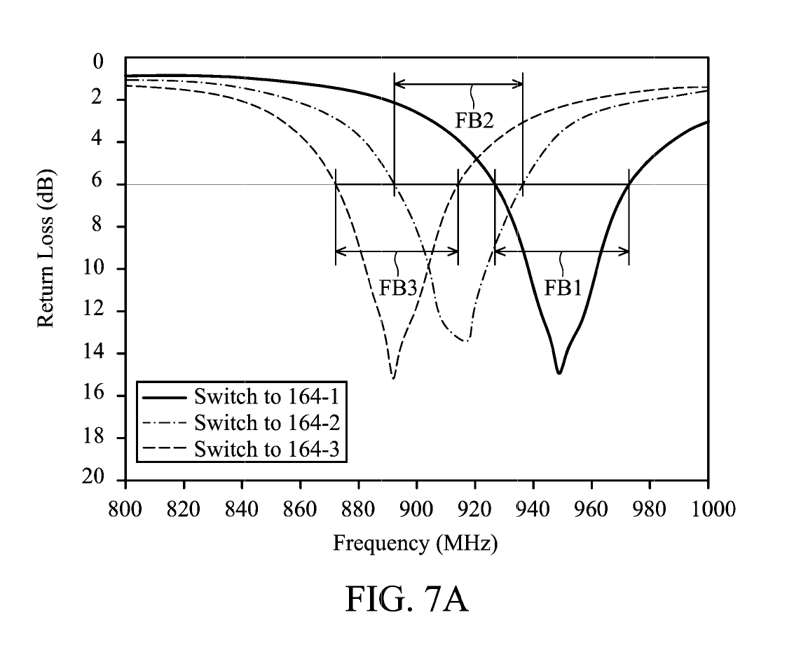

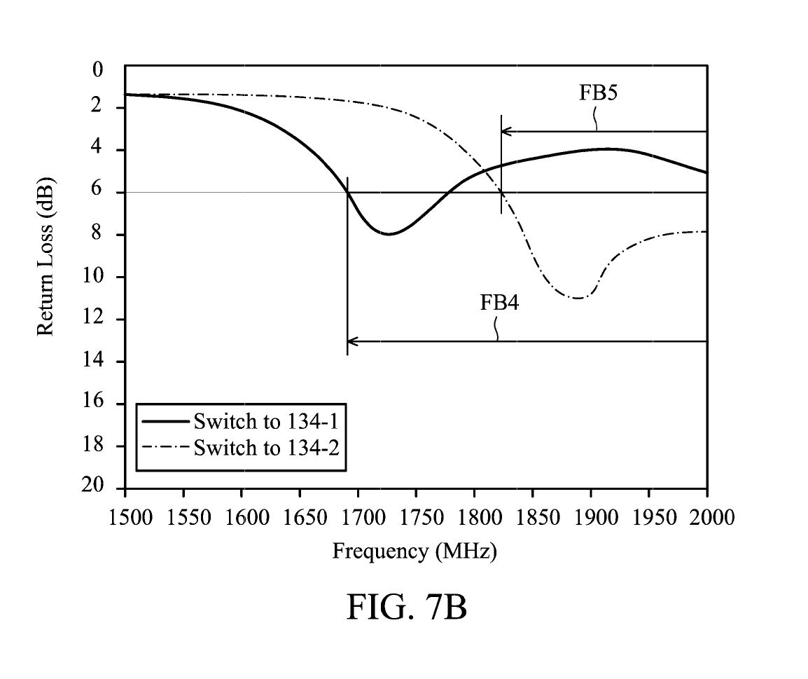

FIG. 7A is a diagram for illustrating return loss of the antenna structure 410 according to an embodiment of the invention. It is assumed that the switch 132 is constantly coupled to the path 134-1 in the embodiment. If the switch 162 is coupled to the path 164-1, the antenna structure 410 can cover a band FB1 from about 925 MHz to 980 MHz. If the switch 162 is coupled to the path 164-2, the antenna structure 410 can cover a band FB2 from about 880 MHz to 960 MHz. If the switch 162 is coupled to the path 164-3, the antenna structure 410 can cover a band FB3 from about 824 MHz to 894 MHz. For low frequencies, the antenna structure 410 can cover at least GSM850/900 bands. The foregoing ranges of the bands FB1, FB2 and FB3 are adjustable to meet different applications.

FIG. 7B is a diagram for illustrating return loss of the antenna structure 410 according to an embodiment of the invention. It is assumed that the switch 162 is constantly coupled to the path 164-1 in the embodiment. If the switch 132 is coupled to the path 134-1, the antenna structure 410 can cover a band FB4 from about 1710 MHz to 2170 MHz. If the switch 162 is coupled to the path 134-2, the antenna structure 410 can cover a band FB5 from about 1850 MHz to 217 0MHz. For high frequencies, the antenna structure 410 can cover at least GSM1800/1900 bands and WCDMA Band 1. The foregoing ranges of the bands FB4 and FB5 are adjustable to meet different applications.

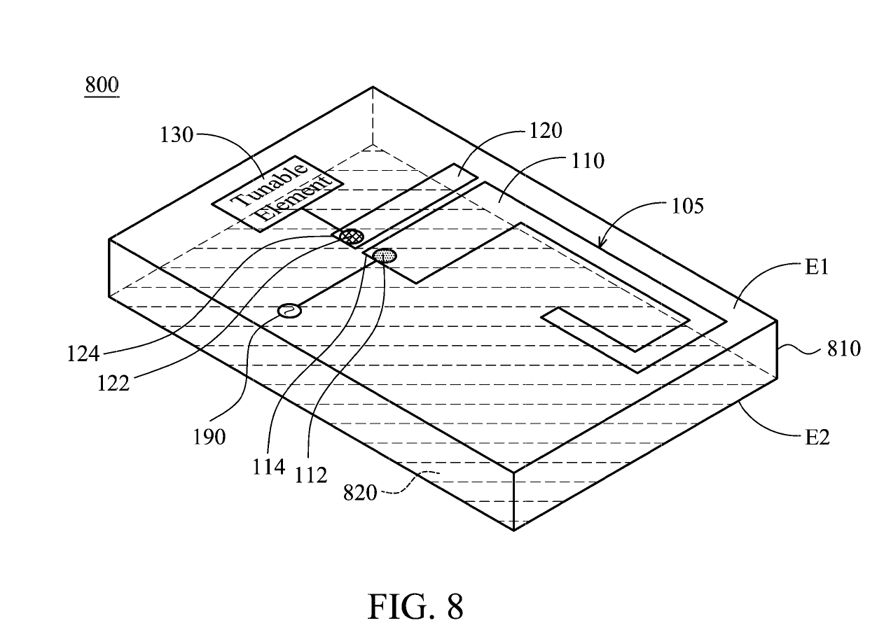

FIG. 8 is a diagram for illustrating a mobile device 800 and the antenna structure 105 therein according to an embodiment of the invention. As shown in FIG. 8, the mobile device 800 further comprises a substrate 810 (e.g., an FR4 substrate) and a ground plane 820. The ground plane 820 may be made of metal, such as copper, silver, or aluminum. In some embodiments, the ground plane 820 provides the ground node VSS as mention above. The substrate 810 has two opposite surfaces E1 and E2. The antenna structure 105, as shown in FIG. 1A, is disposed on the surface E1 of the substrate 810, and the ground plane 820 is disposed on the surface E2 of the substrate 810. Note that the invention is not limited to the above. Every antenna structure in FIGS. 2A-5M may be used in the mobile device 800 and disposed on one surface of the substrate 810. In other embodiments, the ground plane 820 may be removed from the mobile device 800.

By controlling at least one tunable element coupled to at least one parasitical element, the antenna structure of the invention can operate in multiple bands, such as GSM, WCDMA and LTE bands. Furthermore, the antenna structure is very small and may be easily applied to all kinds of mobile communication devices. The mobile device and the antenna structure of the invention not only provide broad bandwidth but also maintain a good radiation performance.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device, comprising:
an antenna structure, comprising:
a main radiation element, having a feeding pin coupled to a signal source, wherein the feeding pin is substantially located at an end of the main radiation element;
a first parasitical element, close to the main radiation element, and having a first parasitical pin, wherein the first parasitical pin is substantially located at an end of the first parasitical element; and
a first tunable element, comprising a first switch and a plurality of paths, wherein the first switch selectively couples one of the paths to the first parasitical pin in such a manner that the antenna structure operates in multiple bands.

2. The mobile device as claimed in claim 1, wherein the first parasitical pin is close to the feeding pin.

3. The mobile device as claimed in claim 1, wherein the first parasitical element is independent of the main radiation element.

4. The mobile device as claimed in claim 1, wherein the main radiation element further has a grounding pin coupled to a ground node.

5. The mobile device as claimed in claim 4, wherein the grounding pin is close to the feeding pin.

6. The mobile device as claimed in claim 1, wherein the antenna structure further comprises:
a second parasitical element, close to the main radiation element, and having a second parasitical pin, wherein the second parasitical pin is substantially located at an end of the second parasitical element; and
a second tunable element, comprising a second switch and a plurality of paths, wherein the second switch selectively couples one of the paths to the second parasitical pin.

7. The mobile device as claimed in claim 6, wherein the second parasitical pin is close to the feeding pin.

8. The mobile device as claimed in claim 6, wherein the second parasitical element is independent of the main radiation element.

9. The mobile device as claimed in claim 1, wherein the antenna structure further comprises:
a second parasitical element, close to the main radiation element, and having a second parasitical pin, wherein the second parasitical pin is substantially located at an end of the second parasitical element, and the second parasitical pin is coupled to a ground node.

10. The mobile device as claimed in claim 9, wherein the second parasitical element is independent of the main radiation element.

11. The mobile device as claimed in claim 1, wherein the antenna structure further comprises:
a first branch, coupled to the main radiation element, and partially surrounded by the main radiation element.

12. The mobile device as claimed in claim 11, wherein the first branch substantially has an I-shape.

13. The mobile device as claimed in claim 11, wherein the antenna structure further comprises:
a second branch, coupled to the first branch, and partially surrounded by the main radiation element.

14. The mobile device as claimed in claim 13, wherein the first branch substantially has an L-shape, and the second branch substantially has an I-shape.

15. The mobile device as claimed in claim 14, wherein the antenna structure further has a grounding pin coupled to a ground node, and the ground pin is substantially located at an end of the first branch.

16. The mobile device as claimed in claim 15, wherein the antenna structure further has a tuning pin substantially located at an end of the second branch, and wherein the mobile device further comprises:
a third tunable element, comprising a third switch and a plurality of paths, wherein the third switch selectively couples one of the paths to the tuning pin.

17. The mobile device as claimed in claim 1, wherein the main radiation element further has a tuning pin, and wherein the mobile device further comprises:
a third tunable element, comprising a third switch and a plurality of paths, wherein the third switch selectively couples one of the paths to the tuning pin.

18. The mobile device as claimed in claim 1, further comprising:
a substrate, having a first surface and a second surface, wherein the antenna structure is disposed on the first surface of the substrate; and
a ground plane, disposed on the second surface of the substrate.

19. The mobile device as claimed in claim 1, wherein the main radiation element substantially has a C-shape.

20. The mobile device as claimed in claim 1, wherein the first parasitical element substantially has an I-shape.
